(19) United States
(12) Patent Application Publication
(10) Pub. No.: US 2017/0041187 A1
(43) Pub. Date: Feb. 9, 2017

(54) MANAGING NETWORK CONNECTIVITY OF A VIRTUAL MACHINE RELATED TO A SHARED POOL OF CONFIGURABLE COMPUTING RESOURCES

(71) Applicant: International Business Machines Corporation, Armonk, NY (US)

(72) Inventors: Philip J. Nelson, Rochester, MN (US); Esha Seth, Lucknow (IN); Andrew T. Thorstensen, Morrisville, NC (US); Wilson P. Ward, Rochester, MN (US)

(21) Appl. No.: 14/839,978

(22) Filed: Aug. 29, 2015

Related U.S. Application Data
(63) Continuation of application No. 14/817,469, filed on Aug. 4, 2015.

(51) Int. Cl. H04L 12/24; H04L 12/721; H04L 12/26

(52) U.S. Cl. CPC H04L 41/0803; H04L 43/0811; H04L 45/38

(57) ABSTRACT

Disclosed aspects include managing network connectivity of a virtual machine related to a shared pool of configurable computing resources. The shared pool of configurable computing resources has a set of virtual machines connected with an integration bridge. Using the shared pool of configurable computing resources, the virtual machine is associated with the set of virtual machines and set of flow mapping data which identifies the virtual machine is determined. The set of flow mapping data is transmitted and the virtual machine is connected with the integration bridge. In embodiments, the virtual machine is disconnected from the integration bridge and a selection is made to connect the virtual machine based on the set of flow mapping data.

### STATEMENT REGARDING PRIOR DISCLOSURES BY THE INVENTOR OR A JOINT INVENTOR

The following disclosure(s) are submitted under 35 U.S.C. 102(b)(1)(A): IBM PowerVC virtualization management enhancements deliver expanded scalability, additional device support, and support for Power Enterprise Servers built on IBM POWER8 technology, IBM Power Virtualization Center Version 1.2.2, Dec. 12, 2014.

### BACKGROUND

This disclosure relates generally to computer systems and, more particularly, relates to managing network connectivity of a virtual machine related to a shared pool of configurable computing resources. The amount of data that needs to be managed by enterprises is increasing. Management of network connectivity may be desired to be performed as efficiently as possible. As data needing to be managed increases, the need for management efficiency may increase.

### SUMMARY

Disclosed aspects include managing network connectivity of a virtual machine related to a shared pool of configurable computing resources. The shared pool of configurable computing resources has a set of virtual machines connected with an integration bridge. Using the shared pool of configurable computing resources, the virtual machine is associated with the set of virtual machines and set of flow mapping data which identifies the virtual machine is determined. The set of flow mapping data is transmitted and the virtual machine is connected with the integration bridge. In embodiments, the virtual machine is disconnected from the integration bridge and a selection is made to connect the virtual machine based on the set of flow mapping data.

In embodiments, network traffic can be routed from the virtual machine to the integration bridge. As such, network traffic may be routed from the integration bridge to an external bridge. In embodiments, the virtual machine may be disconnected from the integration bridge. Accordingly, a selection may be made to connect the virtual machine based on the set of flow mapping data (e.g., to route network traffic from the virtual machine directly to the external bridge). Altogether, performance or efficiency benefits when managing network connectivity may occur (e.g., speed, flexibility, responsiveness, resource usage).

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a cloud computing node according to embodiments;

FIG. 2 depicts a cloud computing environment according to embodiments;

FIG. 3 depicts abstraction model layers according to embodiments;

FIG. 4 shows an example system for managing network connectivity of a virtual machine related to of a shared pool of configurable computing resources according to embodiments; and

FIG. 5 is a flowchart illustrating a method for managing network connectivity of a virtual machine related to of a shared pool of configurable computing resources according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure include associating/importing a virtual machine that is outside of a particular environment; for example, never managed by OpenStack (trademark of the OpenStack Foundation) software. A network configuration of the virtual machine is determined. If the virtual machine is connected directly to an external Linux (trademark of Linus Torvalds) bridge/virtual switch, the virtual machine is reconfigured to connect to the OpenStack integration bridge and create data flows (if necessary) to connect the integration bridge to the external Linux bridge/virtual switch.

Aspects of the disclosure include updating and using a set of flow mapping data (e.g., a network flow mapping file). When a new virtual machine is created (in OpenStack), or when a new virtual machine is imported, the set of flow mapping data is updated with an identifier/name of the virtual machine or other data desired to reconfigure the network configuration (e.g., network interface names, external virtual switch names, external virtual local area network values). If that virtual machine is unmanaged (by the OpenStack environment), the information in the set of flow mapping data may be preserved (e.g., in the network flow mapping file on the compute node which hosts the virtual machine).

Disclosed aspects relate to (e.g., apply to) computing systems with respect to cloud resource managers. OpenStack may represent an illustrative embodiment. OpenStack is a set of software tools for building and managing cloud computing platforms for public and private clouds. Put differently, OpenStack is a cloud operating system that can control large pools of compute, storage, and networking resources throughout a datacenter. OpenStack may be considered Infrastructure as a Service (IaaS). Management may occur utilizing a dashboard that gives administrators control while empowering their users to provision resources through a web interface. Providing infrastructure can include configuring for performance efficiencies in adding one or more new instances, upon which other cloud components may run. In general, the infrastructure then can run a “platform” upon which a developer may create software applications which are delivered to the end users.

Certain virtualization products have tight coupling (e.g., speak/interpret similar language). However, an environment such as OpenStack presents challenges by assuming ownership of the metadata is kept in a central region repository. When using a switch such as Open vSwitch as the networking back-end, OpenStack can use a particular configuration for connecting virtual machines to external networks. The virtual machines are connected to a Linux bridge/virtual switch (e.g., the integration bridge), which is then connected to various external virtual switches that connect the virtual machine to external network connections. Various network flows, based on an internal virtual local area network configuration, may be used to determine which external virtual switch a given virtual machine's outgoing network data is sent to (and vice versa for determining which virtual machine incoming traffic on the external bridge should be sent to once channeled through the integration bridge).

Such configuration presents some challenges when adding functionality to allow for the importing of virtual machines from outside of the OpenStack environment. Virtual machines that are directly connected to the aforementioned external virtual switches may be reconfigured to run through the integration bridge and then the appropriate flows, if they don't exist, may be created to connect the integration bridge to the external virtual switch (and if the flow does exist, the virtual machine network configuration can be set-up in order to direct its network traffic onto the correct flow). Also, OpenStack may assume that all virtual machines using Open vSwitch and running on a given host are already being managed by OpenStack. As such, OpenStack may take full control over the Open vSwitch configuration; accordingly, OpenStack may erase and recreate the configuration on each agent restart based on data contained within the OpenStack data repository. Consequently, virtual machines that were previous managed by OpenStack but are no longer being managed by OpenStack can lose their network connectivity as the corresponding network flow information may not be retained in the OpenStack data repository (and therefore is not recreated).

Aspects of the disclosure include a method, system, and computer program product for managing network connectivity of a virtual machine. The virtual machine is related to a shared pool of configurable computing resources. The shared pool of configurable computing resources have a set of virtual machines. The set of virtual machines are connected with an integration bridge. In certain embodiments, the virtual machine may be hosted by a compute node physically separate from both a controller used to manage the shared pool of configurable computing resources and a set of nodes that host the set of virtual machines. Aspects can include a set of operations for network connectivity management.

Using the shared pool of configurable computing resources (e.g., the controller), the virtual machine is associated with the set of virtual machines and a set of flow mapping data which identifies the virtual machine is determined. In various embodiments, the shared pool of configurable computing resources may ascertain that the virtual machine is a rookie (e.g., new, unrecognized, not previously managed by the shared pool of configurable computing resources). In certain embodiments, the virtual machine may be transitioned from a first state (e.g., in which management by the shared pool of configurable computing resources is absent) to a second state (e.g., in which management by the shared pool of configurable computing resources is present).

Using the shared pool of configurable computing resources, the set of flow mapping data is transmitted and the virtual machine is connected with the integration bridge. In embodiments, the set of flow mapping data may be transmitted to a compute node that hosts the virtual machine (e.g., so that the virtual machine can use the set of flow mapping data when the virtual machine is not associated with the set of virtual machines). In embodiments, the virtual machine can be connected with the integration bridge when the virtual machine is associated with the set of virtual machines.

In embodiments, network traffic can be routed from the virtual machine to the integration bridge. As such, network traffic may be routed from the integration bridge to an external bridge. In embodiments, the virtual machine may be disconnected from the integration bridge. Accordingly, a selection may be made to connect the virtual machine based on the set of flow mapping data (e.g., to route network traffic from the virtual machine directly to the external bridge). Altogether, performance or efficiency benefits when managing network connectivity may occur (e.g., speed, flexibility, responsiveness, resource usage).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

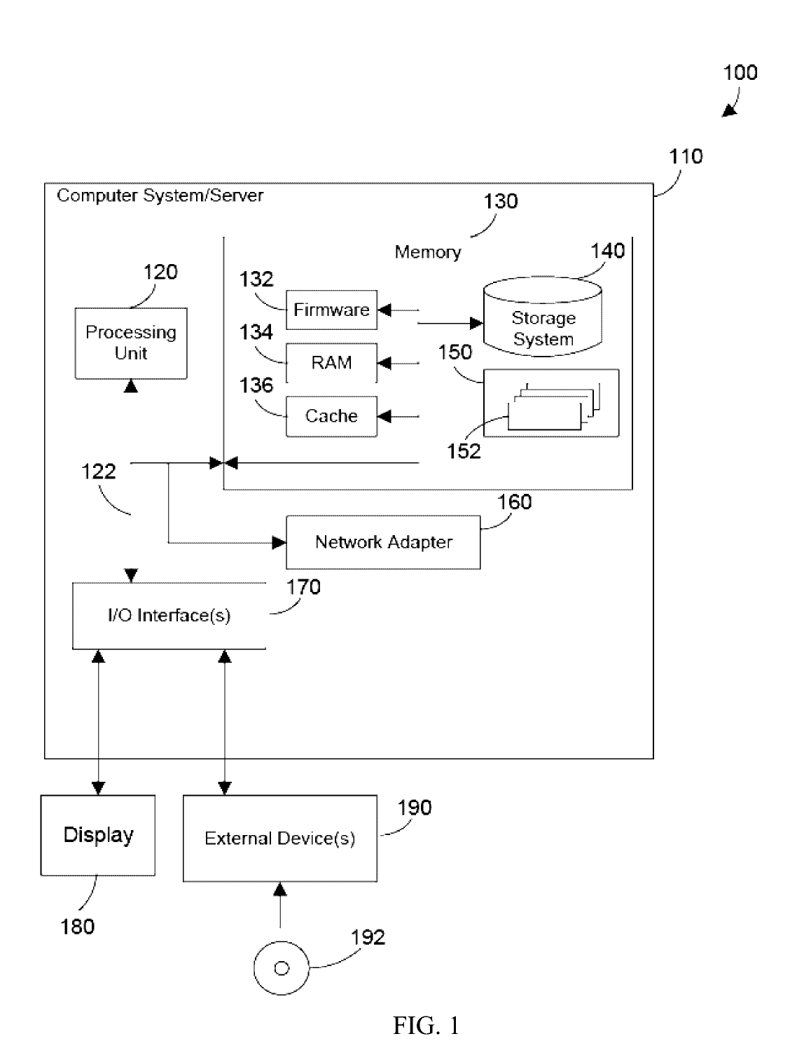

Referring now to FIG. 1, a block diagram of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 110, which is operational with numerous other general purpose or special purpose computing system environments or configurations. Examples of well-known computing systems, environments, and/or configurations that may be suitable for use with computer system/server 110 include, but are not limited to, personal computer systems, server computer systems, tablet computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 110 may be described in the general context of computer system executable instructions, such as program modules, being executed by a computer system. Generally, program modules may include routines, programs, objects, components, logic, data structures, and so on that perform particular tasks or implement particular abstract data types. Computer system/server 110 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 110 in cloud computing node 100 is shown in the form of a general-purpose computing device. The components of computer system/server 110 may include, but are not limited to, one or more processors or processing units 120, a system memory 130, and a bus 122 that couples various system components including system memory 130 to processing unit 120.

Bus 122 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 110 typically includes a variety of computer system readable media. Such media may be any available media that is accessible by computer system/server 110, and it includes both volatile and non-volatile media, removable and non-removable media. An example of removable media is shown in FIG. 1 to include a Digital Video Disc (DVD) 192.

System memory 130 can include computer system readable media in the form of volatile or non-volatile memory, such as firmware 132. Firmware 132 provides an interface to the hardware of computer system/server 110. System memory 130 can also include computer system readable media in the form of volatile memory, such as random access memory (RAM) 134 and/or cache memory 136. Computer system/server 110 may further include other removable/non-removable, volatile/non-volatile computer system storage media. By way of example only, storage system 140 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 122 by one or more data media interfaces. As will be further depicted and described below, memory 130 may include at least one program product having a set (e.g., at least one) of program modules that are configured to carry out the functions described in more detail below.

Program/utility 150, having a set (at least one) of program modules 152, may be stored in memory 130 by way of example, and not limitation, as well as an operating system, one or more application programs, other program modules, and program data. Each of the operating system, one or more application programs, other program modules, and program data or some combination thereof, may include an implementation of a networking environment. Program modules 152 generally carry out the functions and/or methodologies of embodiments of the invention as described herein.

Computer system/server 110 may also communicate with one or more external devices 190 such as a keyboard, a pointing device, a display 180, a disk drive, etc.; one or more devices that enable a user to interact with computer system/server 110; and/or any devices (e.g., network card, modem, etc.) that enable computer system/server 110 to communicate with one or more other computing devices. Such communication can occur via Input/Output (I/O) interfaces 170. Still yet, computer system/server 110 can communicate with one or more networks such as a local area network (LAN), a general wide area network (WAN), and/or a public network (e.g., the Internet) via network adapter 160. As depicted, network adapter 160 communicates with the other components of computer system/server 110 via bus 122. It should be understood that although not shown, other hardware and/or software components could be used in conjunction with computer system/server 110. Examples, include, but are not limited to: microcode, device drivers, redundant processing units, external disk drive arrays, Redundant Array of Independent Disk (RAID) systems, tape drives, data archival storage systems, etc.

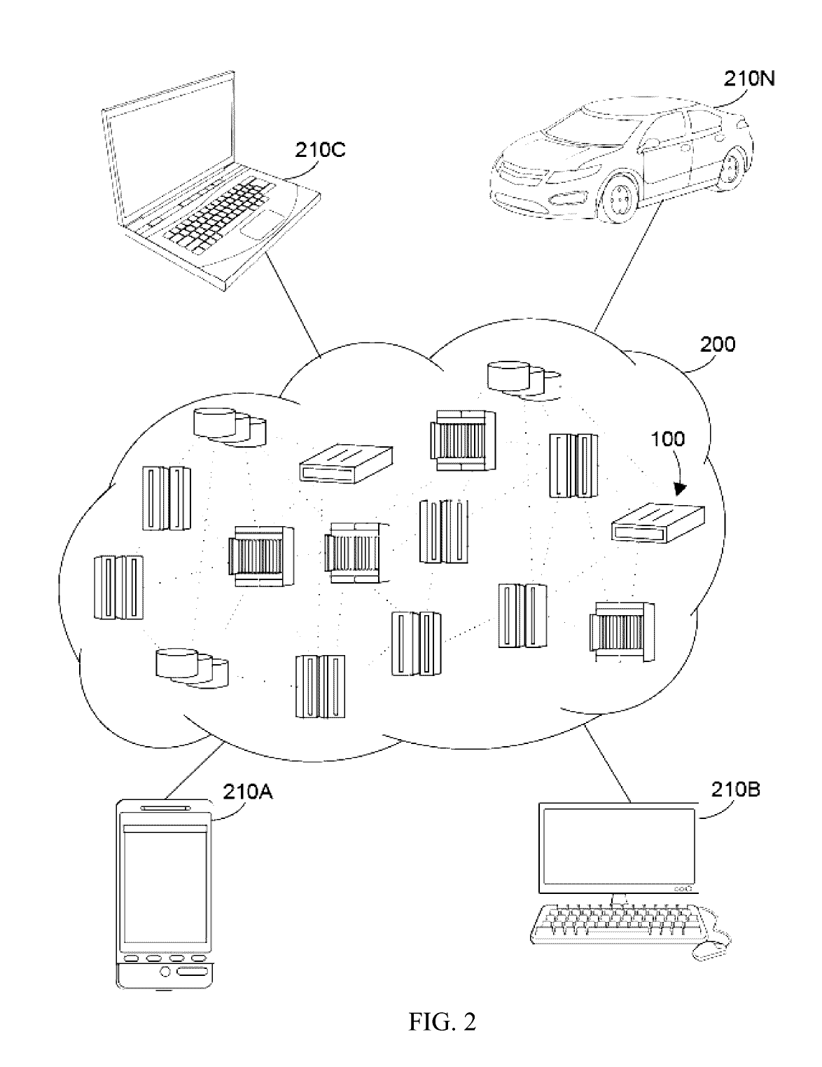

Referring now to FIG. 2, illustrative cloud computing environment 200 is depicted. As shown, cloud computing environment 200 comprises one or more cloud computing nodes 100 with which local computing devices used by cloud consumers, such as, for example, personal digital assistant (PDA) or cellular telephone 210A, desktop computer 210B, laptop computer 210C, and/or automobile computer system 210N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 210A-N shown in FIG. 2 are intended to be illustrative only and that computing nodes 100 and cloud computing environment 200 can communicate with any type of computerized device over any type of network and/or network addressable connection (e.g., using a web browser).

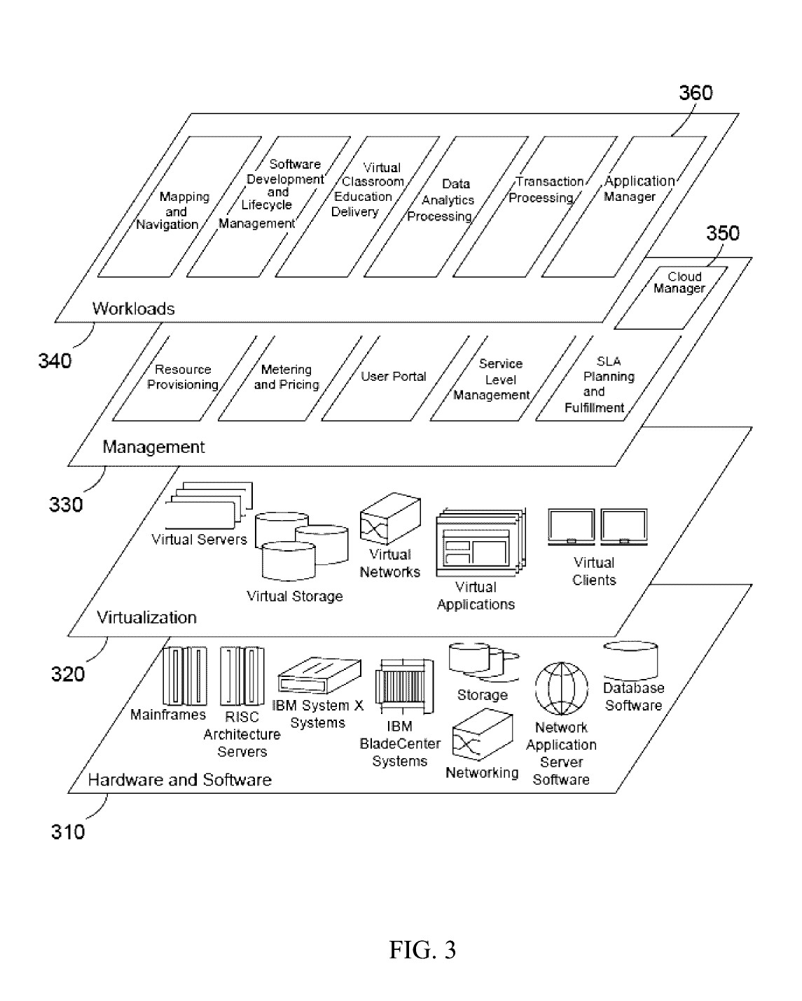

Referring now to FIG. 3, a set of functional abstraction layers provided by cloud computing environment 200 in FIG. 2 is shown. It should be understood in advance that the components, layers, and functions shown in FIG. 3 are intended to be illustrative only and the disclosure and claims are not limited thereto. As depicted, the following layers and corresponding functions are provided.

Hardware and software layer 310 includes hardware and software components. Examples of hardware components include mainframes, in one example IBM System z systems; RISC (Reduced Instruction Set Computer) architecture based servers, in one example IBM System p systems; IBM System x systems; IBM BladeCenter systems; storage devices; networks and networking components. Examples of software components include network application server software, in one example IBM WebSphere® application server software; and database software, in one example IBM DB2® database software. IBM, System z, System p, System x, BladeCenter, WebSphere, and DB2 are trademarks of International Business Machines Corporation registered in many jurisdictions worldwide.

Virtualization layer 320 provides an abstraction layer from which the following examples of virtual entities may be provided: virtual servers; virtual storage; virtual networks, including virtual private networks; virtual applications and operating systems; and virtual clients.

In one example, management layer 330 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A cloud manager 350 is representative of a cloud manager (or shared pool manager) as described in more detail below. While the cloud manager 350 is shown in FIG. 3 to reside in the management layer 330, cloud manager 350 can span all of the levels shown in FIG. 3, as discussed below.

Workloads layer 340 provides examples of functionality for which the cloud computing environment may be utilized. Examples of workloads and functions which may be provided from this layer include: mapping and navigation; software development and lifecycle management; virtual classroom education delivery; data analytics processing; transaction processing; and an application manager 360, which may manage network connectivity as discussed in more detail below.

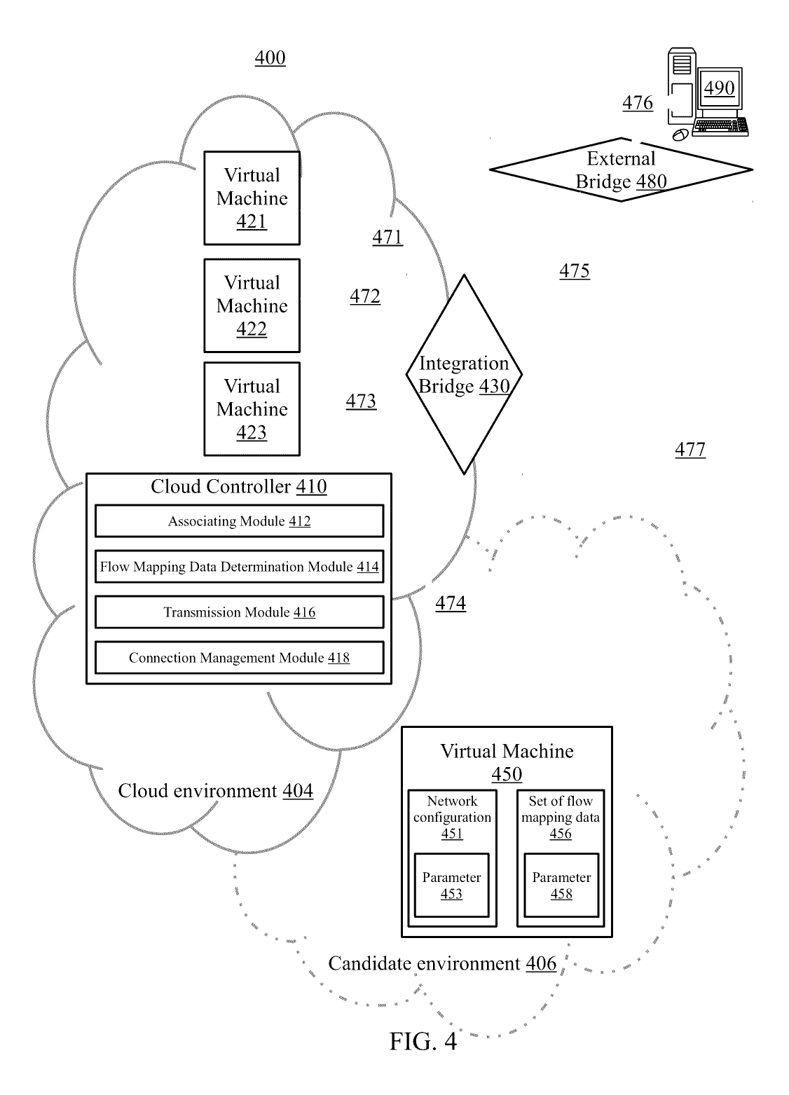

FIG. 4 shows an example system 400 for managing network connectivity of a virtual machine related to of a shared pool of configurable computing resources according to embodiments. The example system may be based on OpenStack, which is an Infrastructure as a Service (IaaS) cloud computing project that is a free open source software. Without a separate methodology, OpenStack may assume ownership of all the metadata is kept in some central region repository. Aspects of the example system may migrate metadata (and backing Input/Output technologies) desired by the central management node with respect to a not-closely-coupled system lacking a threshold computer-oriented cognition of OpenStack. Aspects may include a mechanism for associating/importing a virtual machine which has not previously been managed by OpenStack. Aspects of the example system can include maintaining/keeping/recording networking information with respect to the virtual machine for when the virtual machine becomes unmanaged.

For a virtual machine 450 in a candidate environment 406 not initially managed by a cloud controller 410 (e.g., using OpenStack) but that has been determined (e.g., by a user) to include in the cloud environment 404, an associating module 412 can reconfigure the virtual machine 450 to work within the cloud environment 404 (e.g., which uses OpenStack). From a network connectivity management perspective, a flow mapping data determination module 414 can determine a candidate network configuration 451 (e.g., prior to incorporation into the cloud environment 404 and having a parameter 453) of the virtual machine 450 and then take the appropriate steps to translate that network configuration 451 into the cloud environment 404 (e.g., OpenStack). As such, the virtual machine 450 which was previously connected directly via connection 477 to an external bridge 480 (e.g., an externally facing bridge or virtual switch which can connect to a computer system 490 via connection 476) can be reconfigured to connect to an integration bridge 430 via connection 474 using a connection management module 418. The connection management module 418 can determine if a network flow exists (e.g., used by the set of virtual machines 421, 422, 423 and connection 471, 472, 473) between the integration bridge 430 and the external bridge 480 that the virtual machine 450 was connected to and, if not, it may generate the network flow 475. Aspects of the example system can streamline a change of a virtual machine's core Input/Output technology from a Linux bridge to a software-defined networking capable virtual switch.

The flow mapping data determination module 414 may determine/create a set of flow mapping data 456 (e.g., a network flow mapping file having a parameter 458). The set of flow mapping data 456 can be transmitted using the transmission module 416 in order to reside on a host system of the virtual machine 450. The host system can be external-to/outside-of/separate-from the cloud controller 410, the cloud environment 404, or a normal cloud controller data repository. As such, the host system may be at least a portion of candidate environment 406. The set of flow mapping data 456 can allow for a virtual machine which is managed by the cloud controller 410 to be unmanaged and yet retain its network connectivity (and to allow it to be later remanaged by the cloud controller 410 if desired). The set of flow mapping data 456 can be used when a virtual machine (e.g., virtual machine 450) on the host system that is no longer managed by the cloud controller is restarted (or, in embodiments, when an OpenStack network agent on the host is restarted). As such, instead of relying solely on networking data in the cloud controller data repository (e.g., OpenStack data repository), the set of flow mapping data can be read by the connection management module 418 to determine network connectivity information desired to establish the network configuration for the virtual machine 450 so that its network connectivity can be maintained (e.g., via connection 477). Other implementations are contemplated, the example system 400 is intended to be illustrative while representing the various performance or efficiency benefits.

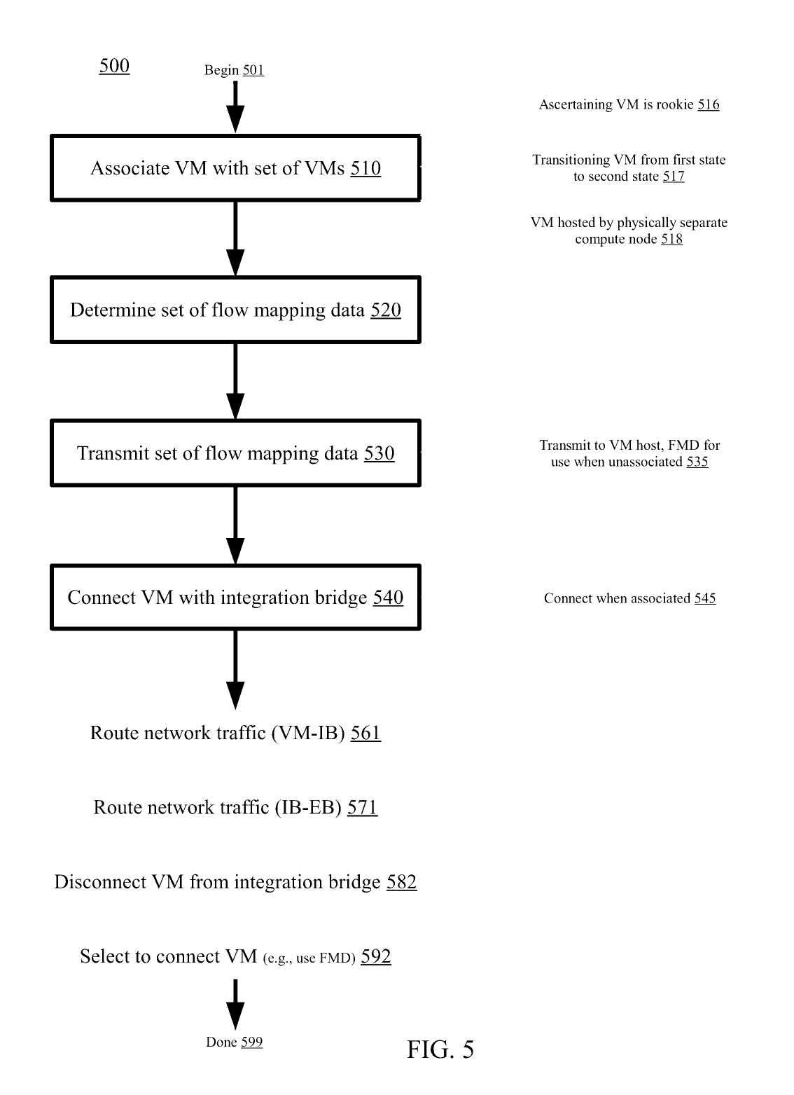

FIG. 5 is a flowchart illustrating a method 500 for managing network connectivity of a virtual machine related to of a shared pool of configurable computing resources according to embodiments. The shared pool of configurable computing resources have a set of virtual machines. The set of virtual machines are connected with an integration bridge. The integration bridge may provide/allow-for interoperability between devices/networks. For example, the integration bridge can include an interface to facilitate communication between devices by interpreting/translating (different) information/languages/messages. As such, the integration bridge can serve to integrate a component into a system (e.g., a virtual machine into a cloud environment). The integration bridge may have a computer network address (e.g., physical address, internet protocol address), can read data from at least one data source, and may have a switching feature (e.g., virtual switch) which processes/routes one or more data packets. Method 500 may begin at block 501.

At block 510, the virtual machine is associated with the set of virtual machines. The association may be performed using the shared pool of configurable computing resources (e.g., a controller related to the shared pool of configurable computing resources which may be internal or external with respect to the shared pool of configurable computing resources). Associating the virtual machine can include importing the virtual machine. For example, importing the virtual machine which has not previously (e.g., never within a threshold temporal period) been managed before by the controller. As another example, associating can include resuming or starting-up the virtual machine in response to the virtual machine having been hibernated or shut-down. Associating the virtual machine with the set of virtual machines can create a relationship (e.g., data flow, communicative coupling). The relationship may be between the virtual machine and the set of virtual machines, between a node/host having the virtual machine and a set of nodes/hosts having the set of virtual machines, or between a candidate computing environment including the virtual machine and a cloud environment including the set of virtual machines (e.g., private cloud, public cloud, hybrid cloud).

In embodiments, the shared pool of configurable computing resources may ascertain that the virtual machine is a rookie at block 516. The rookie may include a new virtual machine which has not been run before with respect to the shared pool of configurable computing resources or the controller. The rookie can be unrecognized to the shared pool of configurable computing resources or the controller by indicating absence of correspondence to historical data having recognized virtual machines. The rookie may have not been previously managed by the shared pool of configurable computing resources or the controller at least within a threshold temporal period such as since the last controller shut-down, since yesterday, or within the past hour.

In embodiments, the virtual machine may be transitioned from a first state to a second state at block 517. The first state may be an operational state in which management by the shared pool of configurable computing resources is absent. The second state may have management by the shared pool of configurable computing resources. For example, the controller may manage the virtual machine in the second state but not in the first state. In certain embodiments, the virtual machine may be transitioned from the second state to the first state (e.g., unmanaged). In response to being unmanaged, the virtual machine may be remanaged (e.g., transitioned from the first state to the second state).

In embodiments, the virtual machine may be hosted by a compute node physically separate from both the controller used to manage the shared pool of configurable computing resources and the set of nodes that host the set of virtual machines at block 518. The compute node may be part of a candidate cloud environment. The controller may be internal to a cloud environment or external to the cloud environment. The controller can manage the cloud environment including virtual machines, etc. In particular, the controller may manage communications or data flow.

At block 520, a set of flow mapping data which identifies the virtual machine is determined. The set of flow mapping data can be determined by the shared pool of configurable computing resources (e.g., the controller). The set of flow mapping data can indicate one or more network flows. As such, the set of flow mapping data can indicate which external virtual switch a given virtual machine's outgoing network data is sent to. Similarly, the set of flow mapping data can indicate which virtual machine incoming traffic on the external bridge should be sent to once channeled through the integration bridge. The set of flow mapping data may be based on an internal virtual local area network configuration. In embodiments, the set of flow mapping data may include a computer network address such as a physical device address or an internet protocol address (or identity/identification information of a like/similar kind/nature with respect to the virtual machine).

At block 530, the shared pool of configurable computing resources (e.g., the controller) transmits the set of flow mapping data. In embodiments, the set of flow mapping data may be transmitted to a compute node that hosts the virtual machine at block 535. Subsequently, the virtual machine can use the set of flow mapping data. For example, the virtual machine can use the set of flow mapping data to connect the virtual machine (e.g., to an external bridge) when the virtual machine is not associated with the set of virtual machines. The set of flow mapping data can include one or more parameters for use by the compute node that hosts the virtual machine to develop at least one connection with a computing device separate from the shared pool of configurable computing resources. The transmission may push/send information so that the compute node can be prepared if a disconnection occurs between the virtual machine and the shared pool of configurable computing resources. As such applications/workloads running or initiated to be run on the virtual machine may have operations stabilized (e.g., without losing network connectivity entirely).

At block 540, the shared pool of configurable computing resources (e.g., the controller) connects the virtual machine with the integration bridge. Connection can be established based on network configuration information. In embodiments, the virtual machine can be connected with the integration bridge when (e.g., in response to, at the same time as) the virtual machine is associated with the set of virtual machines. Establishing connections can direct network flows/traffic among/between the virtual machine, the set of virtual machines, the integration bridge, or the external bridge, etc. Connection of the virtual machine with the integration bridge can be a benefit to overall performance or efficiency the operational computing environment is not tightly coupled with respect to virtualization related to the shared pool of configurable computing resources.

In embodiments, network traffic (e.g., data flow) can be routed from the virtual machine to the integration bridge at block 561. As such, network traffic may be routed from the integration bridge to an external bridge at block 571. Routing may be performed by the controller. The external bridge may be a device similar to that of the integration bridge except for computing resource(s) external to the shared pool of configurable computing resources, the integration bridge, and the virtual machine. In embodiments, the external bridge may be a virtual switch (e.g., external virtual switch for external network connections). In embodiments, routing can include rerouting or routing among various devices.

In embodiments, the virtual machine may be disconnected from the integration bridge at block 582. Accordingly, a selection may be made to connect the virtual machine based on the set of flow mapping data (e.g., to route network traffic from the virtual machine directly to the external bridge) at block 592. Connection/disconnection may be performed by the controller. In embodiments, the compute node hosting the virtual machine may use the set of flow mapping data to select to connect to the external bridge or another external device. Subsequently, the connection from the virtual machine to the external bridge may be made. In embodiments, a set of connections and disconnections may occur (e.g., as the virtual machine comes online or goes offline).

Consider a first example which manages network connectivity. The virtual machine which has a network configuration may be imported (e.g., by the shared pool of configurable computing resources or the controller). The network configuration of the virtual machine can be analyzed (e.g., examined). A first parameter value (e.g., which indicates routing connections) in the network configuration may be detected. The first parameter value can be established (e.g., saved/generated) in the set of flow mapping data. A second parameter value (e.g., to route to the integration bridge) may be assigned in the network configuration. The second parameter value can both differ-from and replace the first parameter value. Based on the second parameter value, network traffic may be routed using the integration bridge. In embodiments, an operation of the first example may be performed in response to another (e.g., operation sequence).

Consider a second example which manages network connectivity. The virtual machine having a network configuration may be generated (e.g., potentially subsequent to disconnection, hibernation, shut-down, or start-up). A first parameter value in the set of flow mapping data can be established (e.g., stored/created). A second parameter value (e.g., compute network address) may be assigned in the network configuration (e.g., to route network traffic using the integration bridge). The second parameter value may differ-from the first parameter value. Based on the second parameter value, network traffic can be routed using the integration bridge. In embodiments, an operation of the second example may be performed in response to another (e.g., operation sequence).

Consider a third example which manages network connectivity. The virtual machine may be disconnected from the integration bridge. The virtual machine having a network configuration based on the set of flow mapping data may be generated. The network configuration of the virtual machine can be analyzed (e.g., inspected). A first parameter value in the network configuration may be detected (e.g., sensed/noticed/comparitively-matched). Based on the first parameter value, network traffic may be routed (e.g., without using the integration bridge). For instance, based on the first parameter value, network traffic can be routed to an external bridge. In embodiments, an operation of the third example may be performed in response to another (e.g., operation sequence).

Method 500 concludes at block 599. Aspects of method 500 may provide performance or efficiency benefits for managing network connectivity of a virtual machine related to a shared pool of configurable computing resources. For example, aspects of method 500 may include positive impacts on flexibility for connection activities by using a set of flow mapping data. Altogether, performance or efficiency benefits when managing network connectivity may occur (e.g., speed, flexibility, responsiveness, resource usage).

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system for managing network connectivity of a virtual machine related to a shared pool of configurable computing resources having a set of virtual machines connected with an integration bridge, the system comprising:
a memory having a set of computer readable computer instructions, and
a processor for executing the set of computer readable instructions, the set of computer readable instructions including:
associating, using the shared pool of configurable computing resources, the virtual machine with the set of virtual machines;
determining, by the shared pool of configurable computing resources, a set of flow mapping data which identifies the virtual machine;
transmitting, from the shared pool of configurable computing resources, the set of flow mapping data; and
connecting, by the shared pool of configurable computing resources, the virtual machine with the integration bridge.

2. The system of claim 1, further comprising:
disconnecting the virtual machine from the integration bridge; and
selecting to connect the virtual machine based on the set of flow mapping data.

3. The system of claim 1, wherein connecting the virtual machine with the integration bridge includes: connecting the virtual machine with the integration bridge when the virtual machine is associated with the set of virtual machines.

4. The system of claim 1, wherein transmitting the set of flow mapping data includes: transmitting, to a compute node that hosts the virtual machine, the set of flow mapping data for use when the virtual machine is not associated with the set of virtual machines.

5. The system of claim 1, further comprising:
importing the virtual machine having a network configuration;
analyzing the network configuration of the virtual machine;
detecting a first parameter value in the network configuration;
establishing the first parameter value in the set of flow mapping data;
assigning a second parameter value in the network configuration, wherein the second parameter value both differs-from and replaces the first parameter value; and
routing, based on the second parameter value, network traffic using the integration bridge.

6. The system of claim 1, further comprising:
generating the virtual machine having a network configuration;
establishing a first parameter value in the set of flow mapping data;
assigning a second parameter value in the network configuration, wherein the second parameter value differs-from the first parameter value; and
routing, based on the second parameter value, network traffic using the integration bridge.

7. The system of claim 1, further comprising:
disconnecting the virtual machine from the integration bridge;
generating the virtual machine having a network configuration based on the set of flow mapping data;
analyzing the network configuration of the virtual machine;
detecting a first parameter value in the network configuration; and
routing, based on the first parameter value, network traffic without using the integration bridge.

8. The system of claim 7, further comprising routing, based on the first parameter value, network traffic to an external bridge.

9. The system of claim 1, further comprising:
routing network traffic from the virtual machine to the integration bridge; and
routing network traffic from the integration bridge to an external bridge.

10. The system of claim 1, wherein associating the virtual machine with the set of virtual machines includes the shared pool of configurable computing resources ascertaining the virtual machine is a rookie.

11. The system of claim 1, wherein associating the virtual machine with the set of virtual machines includes: transitioning the virtual machine from a first state to a second state, wherein management by the shared pool of configurable computing resources is absent in the first state and present in the second state.

12. The system of claim 1, wherein the virtual machine is hosted by a compute node physically separate from both a controller used to manage the shared pool of configurable computing resources and a set of nodes that host the set of virtual machines.

13. A computer program product for managing network connectivity of a virtual machine related to a shared pool of configurable computing resources having a set of virtual machines connected with an integration bridge, the computer program product comprising a computer readable storage medium having program instructions embodied therewith, wherein the computer readable storage medium is not a transitory signal per se, the program instructions executable by a processor to cause the processor to perform a method comprising:
associating, using the shared pool of configurable computing resources, the virtual machine with the set of virtual machines;
determining, by the shared pool of configurable computing resources, a set of flow mapping data which identifies the virtual machine;
transmitting, from the shared pool of configurable computing resources, the set of flow mapping data; and
connecting, by the shared pool of configurable computing resources, the virtual machine with the integration bridge.

14. The computer program product of claim 13, wherein the program instructions are stored in a computer readable storage medium in a data processing system, and wherein the program instructions were downloaded over a network from a remote data processing system.

15. The computer program product of claim 13, wherein the program instructions are stored in a computer readable storage medium in a server data processing system, and wherein the program instructions are downloaded over a network to a remote data processing system for use in a computer readable storage medium with the remote data processing system.
